(19) United States
(12) Patent Application Publication
(10) Pub. No.: US 2011/0290082 A1
(43) Pub. Date: Dec. 1, 2011

(54) ASYMMETRIC-TORQUE PHACOEMULSIFICATION NEEDLE WRENCH

(76) Inventor: Thomas G. Moore, JR., Kirkwood, MO (US)

(21) Appl. No.: 12/787,697

(22) Filed: May 26, 2010

(51) Int. Cl. B25B 13/46

(52) U.S. Cl. 81/60

(57) ABSTRACT

A finger-operable phacoemulsification (“phaco”) needle wrench includes a base that receives a fastening head of a phaco needle. A hollow finger grip extends from the base for at least as long as the portion of the needle extending distally from the fastening head. The grip has asymmetric lobes directed generally outwardly from the grip's central axis. The lobes provide a tightening torque to the needle fastening head in response to a tightening force applied to the lobes by fingers of a user securing the needle to a phaco handpiece. The lobes provide a loosening torque to the needle fastening head in response to a loosening force applied to the lobes by fingers removing the needle from the phaco handpiece. The loosening torque is greater than the tightening torque because of the asymmetric profile of the lobes.

### FIELD

The present disclosure relates to devices to assist in the performance of cataract surgery and more particularly to a phacoemulsification needle wrench for use with ultrasound phacoemulsification handpieces.

### BACKGROUND

This section provides background information related to the present disclosure which is not necessarily prior art.

An ophthalmologist performing cataract surgery typically uses an ultrasound handpiece to which a phacoemulsification (“phaco”) needle is attached. The tip of the needle vibrates at ultrasonic frequency to emulsify a cataract. Remains of the cataract and fluids are aspirated from the eye through the needle tip.

### SUMMARY

This section provides a general summary of the disclosure, and is not a comprehensive disclosure of its full scope or all of its features.

In one configuration, the present disclosure is directed to a finger-operable phacoemulsification (“phaco”) needle wrench. The wrench includes a base having a central opening configured to receive a fastening head of a phaco needle. A hollow finger grip extends from the base and has a length at least equal to the length of the portion of the needle extending distally from the fastening head. The grip has a plurality of lobes directed generally outwardly from the grip, each lobe having an asymmetric profile. The lobes are configured to provide a user the ability to apply (a) a tightening torque to the needle fastening head in response to a tightening force applied to the lobes by fingers of a user securing the needle to a phaco handpiece, and (b) a loosening torque greater than the tightening torque to the needle fastening head in response to a loosening force applied to the lobes by fingers removing the needle from the phaco handpiece. The loosening torque is greater than the tightening torque because of the asymmetric profile of the lobes.

In another configuration, the disclosure is directed to a finger-operable phacoemulsification (“phaco”) needle wrench. The wrench includes a finger grip having opposing ends and a lumen therebetween, and a base at the proximal end of the grip. The base has a central opening configured to fit around a fastening head of a phaco needle. The finger grip is configured to receive a distal portion of the needle in the lumen such that a tip of the needle does not extend beyond the distal end of the grip. The finger grip has a plurality of lobes directed generally outwardly from the grip, each lobe having an asymmetric profile. The lobes are configured to provide a user the ability to apply (a) a tightening torque to the needle fastening head in response to a tightening force manually applied to the lobes by a user securing the needle to a phaco handpiece, and (b) a loosening torque greater than the tightening torque to the needle fastening head in response to a loosening force manually applied to the lobes by a user removing the needle from the phaco handpiece. The loosening torque is greater than the tightening torque because of the asymmetric profile of the lobes.

In yet another configuration, the disclosure is directed to a method of using a phacoemulsification (“phaco”) needle in relation to a phaco handpiece. A fastening head of the needle is fitted into an opening in the base of a phacoemulsification needle wrench, the wrench having a finger grip, including a plurality of lobes directed generally outwardly from the grip, each lobe having an asymmetric profile. A tightening force is manually applied onto the lobes of the finger grip to obtain a tightening torque for securing the needle to the phaco handpiece. A loosening torque is obtained to remove the needle from the phaco handpiece, the loosening torque having a magnitude greater than a magnitude of the tightening torque. The greater loosening torque is obtained because of the asymmetric profile of the lobes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partially exploded view of a conventional phaco handpiece;

FIG. 2 is a perspective view of a finger-operable phacoemulsification needle wrench, in accordance with one implementation of the disclosure;

FIG. 3 is an end view of a finger-operable phacoemulsification needle wrench, in accordance with one implementation of the disclosure;

FIG. 4 is a sectional view of a finger-operable phacoemulsification needle wrench, in accordance with one implementation of the disclosure;

FIG. 5 is a sectional view of a finger-operable phacoemulsification needle wrench, in accordance with one implementation of the disclosure, shown with a phaco needle therein; and

FIG. 6 is an end view of a plurality of phacoemulsification needle wrench finger grips, in accordance with various implementations of the disclosure.

Corresponding reference numerals indicate corresponding parts throughout the several views of the drawings.

### DETAILED DESCRIPTION

Example embodiments will now be described more fully with reference to the accompanying drawings.

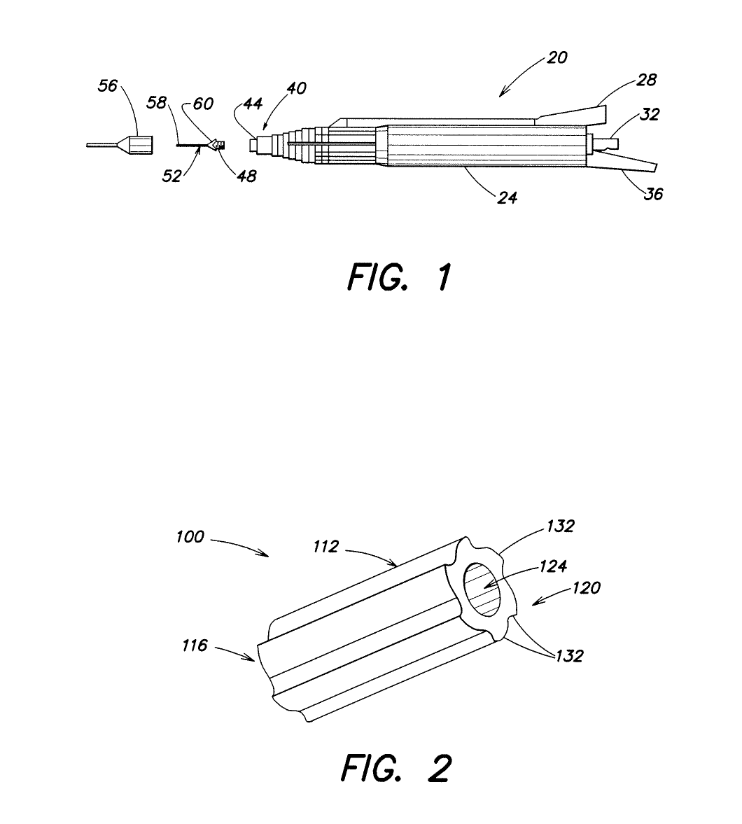

A conventional phaco handpiece is indicated generally in FIG. 1 by reference number 20. The handpiece 20 includes a body 24, an irrigation port 28, an aspiration port 32, and a power cord 36. A distal end 40 of the handpiece 20 has an internally threaded receptacle 44. An externally threaded base 48 of a phaco needle 52 may be screwed into the receptacle 44 to attach the needle 52 to the handpiece 20. A needle sleeve 56 is attached to the handpiece 20 over the needle 52. The needle 52 has a tip 58 and a fastening head 60 that may be turned, e.g., in a clockwise direction to attach the threaded needle base 48 to the handpiece 20. The fastening head 60 is turned in the opposite direction to remove the needle 52 from the handpiece 20.

An ophthalmologist or other user who attaches and/or removes a phaco needle relative to a phaco handpiece must apply appreciable torque to the needle fastening head 60 while avoiding the sharp tip 58 of the needle. It can be particularly desirable to avoid contact with the tip 58 after the needle has been used in a phaco procedure. In various implementations of the disclosure, a finger-operated phaco needle wrench shields the user's fingers from the needle 52 when the user is attaching or removing the needle. Additionally, the wrench facilitates removal of the needle 52 by providing a cross-sectional geometry allowing a user to apply more torque to the fastening head 60 during needle removal than during needle attachment.

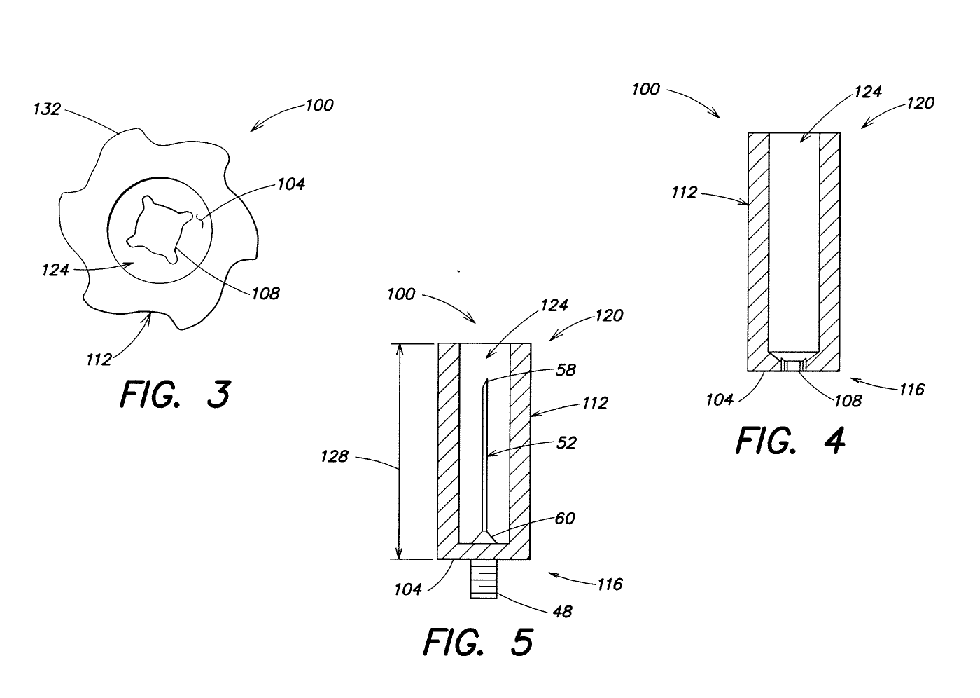

A finger-operated phaco needle wrench, in accordance with one implementation of the disclosure is indicated generally in FIGS. 2-5 by reference number 100. The wrench 100 has a base 104 (shown in FIGS. 3-5) having a central opening 108 configured to receive the needle fastening head 60. A finger grip 112 extends from the base 104 and surrounds the needle 52 when the base 104 receives the needle fastening head 60. The grip 112 has opposing ends 116 and 120. The grip 112 has a lumen 124 between the ends 116 and 120. The grip 112 has a length 128 that is at least equal to the length of the portion of the needle 52 extending distally from the fastening head 60.

The grip 112 has a plurality of lobes 132 directed generally outwardly from the grip. Each lobe 132 has an asymmetric cross-sectional profile. The asymmetric curvature of the lobes 132 is configured to provide a user the ability to apply torques to the needle fastening head 60 that are different for the same force applied to the grip 112, dependent on whether the force is applied clockwise or counterclockwise. The wrench 100 can provide a tightening torque to the needle fastening head 60 in response to a tightening force applied to the lobes 132 when a user turns the grip, e.g., clockwise for a right-hand threaded needle with his/her fingers to secure the needle fastening head 60 to the handpiece 20. The wrench 100 can also provide a loosening torque to the needle fastening head 60 in response to a loosening force applied to the lobes 132 when a user turns the grip, e.g., counterclockwise his/her fingers to remove the needle from the handpiece 20. Because of the asymmetric profile curvature of the lobes 132, the loosening torque is greater than the tightening torque.

In various configurations, the needle wrench 100 may be reusable and made of stainless steel or other materials that will not allow opening to be deformed during use. The needle wrench 100 provides adequate, but not excessive tightening torque so that the needle 52 remains attached to the handpiece 20 when ultrasonic energy is engaged to vibrate the needle (typically in the range of 20 to 40 kilohertz.) The general diameter of the needle wrench 100 may be about 0.5 inches or other diameter suitable for gripping. Once a phacoemulsification procedure is completed, the needle 52 is removed from the handpiece 20, e.g., to allow handpiece cleaning and needle cleaning or disposal. So that the needle may be easily and readily removed, the wrench 100 allows a user to generate a torque for loosening the needle 52 that exceeds the torque previously applied to tighten the needle. Said another way, if the same user tightens and loosens the needle 52, that user, because of the asymmetric lobe profiles can easily generate more loosening torque than tightening torque.

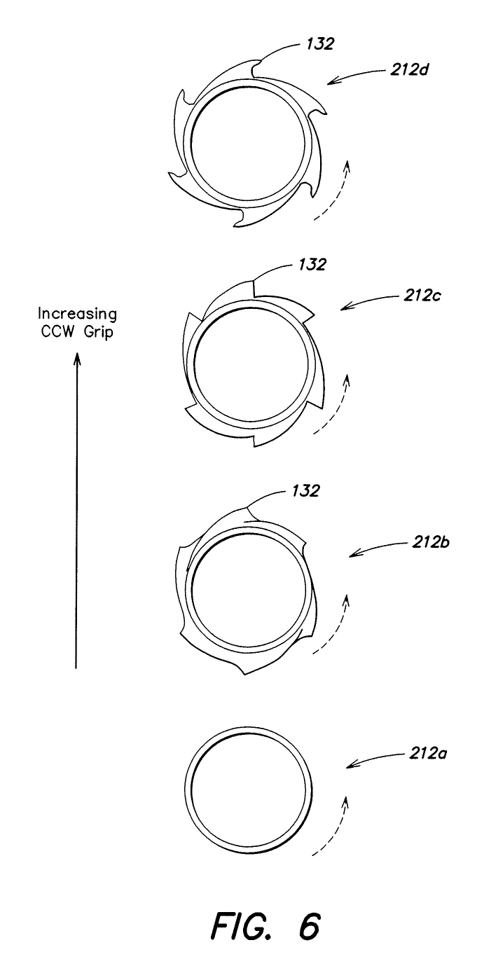

Various curvatures may be used in configuring lobes of the finger grip 112. A comparison of various exemplary curvatures may be made with reference to FIG. 6, in which a plurality of grips 212a-212d are shown. The grip 212a has little if any lobe curvature and would provide little or no difference in the amount of torque generated in either direction. The curvature of lobes 132 in the grip 212d is the most outwardly directed of the grips 212a-212d. Accordingly, compared to torque provided by grips 212a-212c, the most torque is available to a user turning the grip 212d in a counterclockwise direction to remove a phaco needle.

Although six (6) substantially equally spaced lobes 132 are provided on the grip 112 as shown in the Figures, other numbers, spacing, and shapes of lobes could be provided. Sufficient lobes (e.g., more than 2 or 3 lobes) may be provided so that torque can be limited in the tightening direction compared to the torque that may be created in the loosening direction. Additionally or alternatively, fewer than, e.g., 10 to 12 lobes may be provided to enhance the difference between tightening and loosening torques. Also, preferably the lobes 132 extend substantially along the length of grip 112; though it will be appreciated that lobes must be formed on only a portion of grip 112.

While the above description was provided with respect to a conventional right-hand thread assembly, it is noted that the present invention can also be applied to a left-hand thread assembly, where a counterclockwise turn of the wrench tightens a phaco needle and a clockwise turn of the wrench loosens the phaco needle. This can be accomplished by reversing the lobe profiles described above.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of a device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A finger-operable phacoemulsification (“phaco”) needle wrench comprising:
a base having a central opening configured to receive a fastening head of a phaco needle;
a hollow finger grip extending from the base and having a length at least equal to the length of the portion of the needle extending distally from the fastening head, the grip having a plurality of lobes directed generally outwardly from the grip, each lobe having an asymmetric profile;
the lobes configured to provide a user the ability to apply (a) a tightening torque to the needle fastening head in response to a tightening force applied to the lobes by fingers of a user securing the needle to a phaco handpiece, and (b) a loosening torque greater than the tightening torque to the needle fastening head in response to a loosening force applied to the lobes by fingers removing the needle from the phaco handpiece; and
wherein the loosening torque is greater than the tightening torque because of the asymmetric profile of the lobes.

2. The phaco needle wrench of claim 1, the grip configured to surround the needle when the base receives the needle fastening head.

3. The phaco needle wrench of claim 1, wherein the lobes are substantially equally spaced around the grip.

4. The phaco needle wrench of claim 1, the plurality of lobes comprising more than three and fewer than twelve lobes.

5. The phaco needle wrench of claim 1, comprising six lobes.

6. The phaco needle wrench of claim 1, made of stainless steel.

7. The phaco needle wrench of claim 1, the lobes extending substantially along the length of the grip.

8. A finger-operable phacoemulsification (“phaco”) needle wrench comprising:
a hollow finger grip having opposing ends and a lumen therebetween;
a base at one end of the grip, the base having a central opening configured to fit around a fastening head of a phaco needle;
the finger grip configured to surround the needle such that a tip of the needle does not extend beyond the grip;
the finger grip having a plurality of lobes directed generally outwardly from the grip, each lobe having an asymmetric profile;
the lobes configured to provide a user the ability to apply (a) a tightening torque to the needle fastening head in response to a tightening force manually applied to the lobes by a user securing the needle to a phaco handpiece, and (b) a loosening torque greater than the tightening torque to the needle fastening head in response to a loosening force manually applied to the lobes by a user removing the needle from the phaco handpiece; and
the loosening torque is greater than the tightening torque because of the asymmetric profile of the lobes.

9. The phaco needle wrench of claim 8, wherein the lobes are substantially equally spaced around the grip.

10. The phaco needle wrench of claim 8, the plurality of lobes comprising more than three and fewer than twelve lobes.

11. The phaco needle wrench of claim 8, comprising six lobes.

12. The phaco needle wrench of claim 8, made of stainless steel.

13. The phaco needle wrench of claim 8, the lobes extending substantially between the opposing ends of the grip.
